(19) United States
(12) Patent Application Publication
(10) Pub. No.: US 2014/0244548 A1
(43) Pub. Date: Aug. 28, 2014

(54) SYSTEM, METHOD, AND COMPUTER PROGRAM PRODUCT FOR CLASSIFICATION OF SILICON WAFERS USING RADIAL SUPPORT VECTOR MACHINES TO PROCESS RING OSCILLATOR PARAMETRIC DATA

(71) Applicant: NVIDIA CORPORATION, Santa Clara, CA (US)

(72) Inventor: Saul Costa Rosa, San Francisco, CA (US)

(73) Assignee: NVIDIA CORPORATION, Santa Clara, CA (US)

(21) Appl. No.: 13/775,068

(22) Filed: Feb. 22, 2013

(51) Int. Cl. G06N 99/00

(52) U.S. Cl. CPC G06N 99/005
USPC 706/12

(57) ABSTRACT

A system, method, and computer program product for testing and classifying silicon wafers using a support vector machine. The method includes the steps of receiving parametric data associated with one or more die on a wafer and analyzing the parametric data via a support vector machine to determine a classification for each die of the one or more die. The parametric data includes at least one ring oscillator ratio. The method further includes the step of determining a classification of the wafer based on the classification of the one or more die.

### FIELD OF THE INVENTION

The present invention relates to quality control of manufacturing processes, and more particularly to the classification of silicon wafers.

### BACKGROUND

Manufacturing processes and tools have a large impact on the quality of integrated circuits that are fabricated on a silicon wafer. Due to the intensive nature of measuring large amounts of parametric data necessary to classify whether a given die (i.e., a particular integrated circuit from a silicon wafer) is reliable, only a small sample of die are selected and tested to determine whether the wafer should be passed or discarded. As the production line matures, fewer samples are tested and manufacturers may lose the ability to reliably track production quality issues. Fabrication plants have attempted to solve this issue by embedding dummy measurement structures that have no functional purpose other than to measure certain process changes in order to help identify quality control issues. However, these structures have specific limitations.

One common structure used to identify quality control issues relies on voltage controlled oscillators (VCOs). These VCOs (i.e., ring oscillators) generate test signals that measure a singular effect of one particular die on the silicon wafer. Values that show a significant shift from the expected output of the VCO may be readily caught by the testing procedure and used to reject the die (or wafer) as faulty and adjust various processes or tools to correct any issues with the manufacturing process of further wafers. Because each value is only directly related to a singular effect on one die, small shifts from the expected output may not be significant enough to indicate an issue with the manufacturing process at the early stage in production. There is no known algorithm for analyzing these effects to predict whether wafers will be rejected during late stages of testing, once the integrated circuits have already been integrated into products and replacing singular components becomes expensive. Thus, there is a need for addressing this issue and/or other issues associated with the prior art.

### SUMMARY

A system, method, and computer program product for testing and classifying silicon wafers using a support vector machine. The method includes the steps of receiving parametric data associated with one or more die on a wafer and analyzing the parametric data via a support vector machine to determine a classification for each die of the one or more die. The parametric data includes at least one ring oscillator ratio. The method further includes the step of determining a classification of the wafer based on the classification of the one or more die.

### BRIEF DESCRIPTION OF THE DRAWINGS

FIG. 1 illustrates a flowchart of a method for testing and classifying silicon wafers, in accordance with one embodiment;

FIG. 2A illustrates a wafer produced by a fabrication plant, in accordance with one embodiment;

FIG. 2B illustrates a die of the wafer of FIG. 2A, in accordance with one embodiment;

FIG. 3A illustrates a first ring oscillator, in accordance with one embodiment;

FIG. 3B illustrates a second ring oscillator, in accordance with one embodiment;

FIG. 3C illustrates a timing diagram for the output signal of the ring oscillators of FIGS. 3A and 3B, in accordance with one embodiment;

FIG. 4 illustrates a system for analyzing parametric data collected from a wafer, in accordance with one embodiment;

FIG. 5 illustrates a flowchart of a method for testing and classifying silicon wafers, in accordance with one embodiment; and

FIG. 6 illustrates an exemplary system in which the various architecture and/or functionality of the various previous embodiments may be implemented.

### DETAILED DESCRIPTION

The system, method and computer program product described below utilize a machine-learning model to determine a wafer classification based on a plurality of parameters. Some combinations of parameters may be highly correlated while other combinations of parameters have little effect on each other. Given a detailed study of the integrated circuit design, it may be possible to discover the dependent qualities between some parameters, but it is highly unlikely that studying the design will enable a chip designer to understand the dependent relationships between all of the parameters, especially when the number of parameters associated with each die becomes high (e.g., 50, 100, etc.) and when effects between neighboring die are taken into account. The system described herein enables the early classification of wafers as pass/fail, which is typically not discovered until much later in production. Early classification can account for significant savings in test time for poor quality silicon wafers and provide early feedback to the fabrication plant on the quality of the manufacturing process.

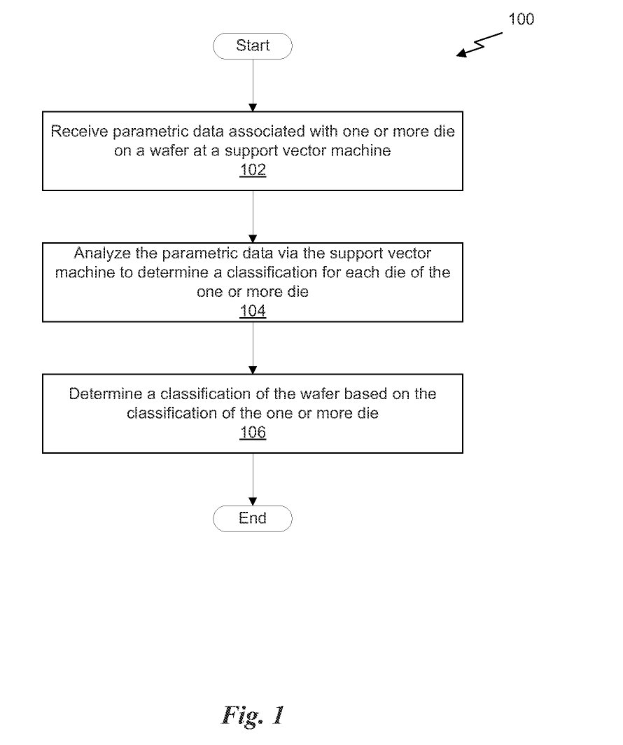

FIG. 1 illustrates a flowchart of a method 100 for testing and classifying silicon wafers, in accordance with one embodiment. At step 102, parametric data associated with one or more die on a wafer is received by a support vector machine. The support vector machine is a machine-learning model that generates a prediction of a classification of die on a wafer based on a set of training data for previously tested wafers. The parametric data may include values associated with a plurality of ring oscillators embedded into the integrated circuit. At step 104, the support vector machine analyzes the parametric data via the support vector machine to determine a classification for each die of the one or more die. The one or more die may represent a sample of the total number of die on the wafer. At step 106, a classification of the wafer is determined based on the classification of the one or more die.

It should be noted that, while various optional features are set forth herein in connection with managing dynamic task-dependency graphs, such features are for illustrative purposes only and should not be construed as limiting in any manner. In one embodiment, the scheduling mechanism described above is implemented in a parallel processing unit.

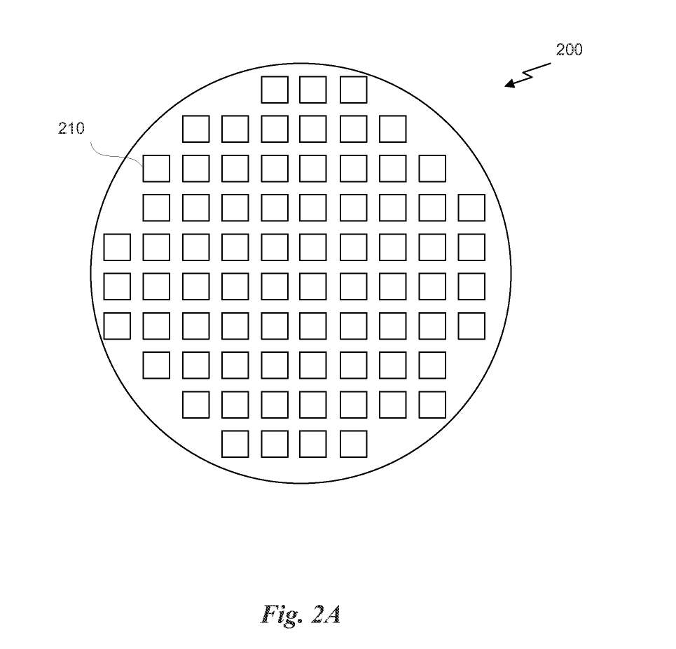

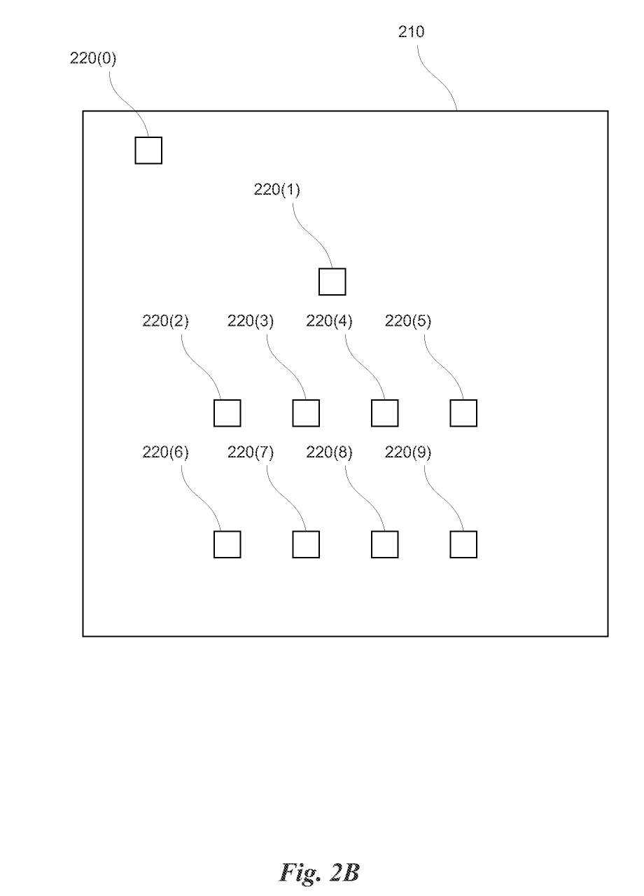

FIG. 2A illustrates a silicon wafer 200 produced by a fabrication plant, in accordance with one embodiment. The wafer 200 is made from a semiconductor substrate such as silicon crystals. As is known in the art, raw silicon wafers are available in a variety of sizes from approximately 25 mm to over 300 mm in diameter. As the wafer 200 is processed, a plurality of die 210 is formed thereon. Each die 210 is a separate and distinct integrated circuit. In one embodiment, the die 210 may comprise a graphics processing unit that is configured to process graphics data and generate pixel data for display on a display device such as a liquid crystal display. It will be appreciated that the die 210 may be any type of integrated circuit formed using conventional wafer processing techniques.

As shown in FIG. 2A, the wafer 200 includes 75 individual die 210. The number of die 210 that are included on a particular wafer 200 may vary depending on the size of the wafer 200 and the dimensions of the integrated circuit that form the die 210. It will be appreciated that the number of die 210 shown in FIG. 2A is for illustrative purposes and that any number and configuration of die 210 is within the scope of the present disclosure.

FIG. 2B illustrates a die 210 of the wafer 200 of FIG. 2A, in accordance with one embodiment. Although not shown explicitly, the die 210 includes an integrated circuit such as a graphics processing unit. The integrated circuit may include various interfaces such as pads for connecting the circuit to leads of a package that may be connected to one or more external components. The integrated circuit may also include various sub-units such as streaming processors, a memory interface, a crossbar, etc. Each die 210 may include a number of test sites which allow a probe to make electrical connections with the integrated circuit before the die has been sliced from the wafer 200 and packaged. The probes may contact the surface of the die 210 at the test sites with one or more pins that are coupled electronically to various signals or voltages, thereby enabling the die 210 to be tested prior to the wafer 200 being sliced to determine whether the die 210 is reliable or faulty.

Full functional testing of each die 210 is a time intensive process. A set of vectors (i.e., signals) may be input to various sub-units of the die 210 using the test sites. The vectors cause the integrated circuit to produce a result, which is compared against an expected result to determine whether the die 210 is operating properly. Each die 210 may be tested against thousands or millions of different vectors. A probe is applied to one or more die 210 of the wafer 200 for testing, and then the probe is move to one or more other die 210 on the wafer 200 until each of the wafers have been tested. While full functional testing of each die 210 is very effective at determining which die 210 are defective, it is extremely time consuming. During normal production of integrated circuits, full functional testing may cause a bottleneck in the production line, thereby making full functional testing of every die 210 impossible or at least cost prohibitive. One solution to reduce the length of time it takes to perform full functional testing of every die 210 is to only test a sample of die 210 from each wafer 200. For example, only 15 of the 75 die 210 may be tested. The results of the 15 tests are then used to classify the wafer as “pass” or “fail”. The good wafers are then sliced and packaged as most of the resulting integrated circuits are presumed to be reliable based on the samples taken. The bad wafers are separated from the batch to either be discarded or to fully tested to determine which die 210 can be kept and which die 210 should be discarded.

Another solution that has been attempted to reduce testing time is to embed testing sub-units in each die 210 that are configured to apply certain test vectors to different sub-units of the integrated circuit. As shown in FIG. 2B, each die 210 may include a plurality of different testing sub-units 220 at different locations within the die 210. The testing sub-units 220 may be enabled, such that they generate a pre-configured test signal. The test signal is then measured and a value is stored in a register of the testing sub-units 220. The value may be retrieved by the probe to generate parametric data associated with the quality of the integrated circuit. In one embodiment, each testing sub-unit 220 includes at least two ring oscillators. The ring oscillators are configured to generate an oscillating square wave at a particular frequency based on the number of elements in a delay line and the propagation delay for each of the elements. The quality of the integrated circuit at the location of the testing sub-unit 220 may cause the frequency of the signal generated by the ring oscillators to be slightly faster or slightly slower than the ideal ring-oscillator based on the design. Measuring propagation delay of the elements in the delay line by measuring the frequency of the signal generated by the ring oscillators provides a tester with information about the quality of the integrated circuit.

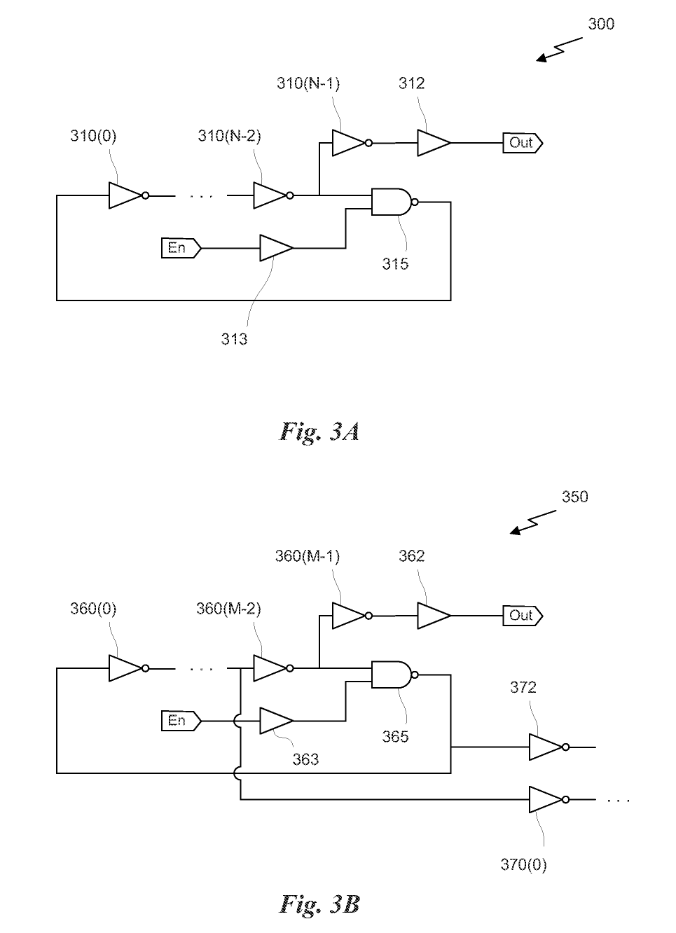

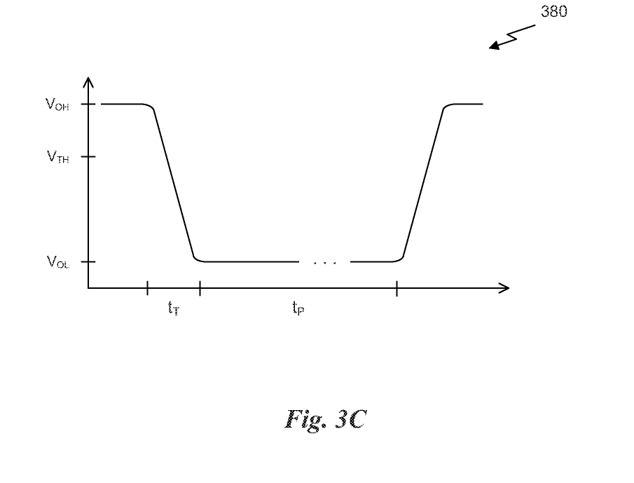

FIG. 3A illustrates a first ring oscillator 300, in accordance with one embodiment. As shown in FIG. 3A, the first ring oscillator 300 includes a delay line including N inverters 310, where N is an odd number that causes the output of the first ring oscillator 300 to produce a square wave. The output of the last inverter 310(N−1) is coupled to an output buffer 312. An enable input is coupled to an input buffer 313 having an output coupled to one input of a NAND gate 315. The other input of the NAND gate 315 is coupled to the output of the second to last inverter 310(N−2) in the delay line. In one embodiment, the first ring oscillator 300 includes 53 inverters 310 in the delay line (i.e., N is equal to 53). It will be appreciated that output of the second to last inverter 310(N−2) is coupled to the NAND gate 315 rather than the last inverter 310(N−1) because the NAND gate 315 inverts the signal the odd number of times to route the output back to the first inverter 310(0) in the delay line when the enable signal is high.

It will be appreciated that the first ring oscillator 300 is just one example of a circuit for a ring oscillator. A myriad of other circuit designs for ring oscillators are possible and within the scope of the present disclosure. For example, the NAND gate 315 may be left out of the design of a ring oscillator that is not configured to operate based on an enable signal. In such a design, the ring oscillator will produce an oscillating signal when a supply voltage is provided to the inverters. Other types and examples of ring oscillators are well known in the art and may be used herein in lieu of the first ring oscillator 300.

FIG. 3B illustrates a second ring oscillator 350, in accordance with one embodiment. The second ring oscillator 350 is similar to the first ring oscillator 300 in that the second ring oscillator 350 includes a delay line including M inverters 360, where M is an odd number. The second ring oscillator 350 has a fan out of four (FO4), which means that the gate capacitance of each inverter in the delay line is four times the gate capacitance of the previous inverter in the delay line. The output of the last inverter 360(M−1) is coupled to an output buffer 362. An enable input is coupled to an input buffer 363 coupled to one input of a NAND gate 365. The other input of the NAND gate 365 is coupled to the output of the second to last inverter 360(M−2) in the delay line. The number M of inverters 360 in the second ring oscillator 350 may be different than the number N of inverters 310 in the first ring oscillator 300. In one embodiment, the second ring oscillator 350 includes 23 inverters 360.

As also shown in FIG. 3B, the output of the NAND gate 365 is coupled to another inverter 372 and the input of the second to last inverter 360(M−2) in the delay line is coupled to another delay line including a plurality of inverters 370. In one embodiment, the output of inverter 372 is connected to a plurality of NAND gates (not shown) that are implemented in order to add a capacitive load to the output of the last stage (e.g., the NAND gate 365). Additional loads can be coupled to the outputs of one or more inverters 360 in the delay line in lieu of or in addition to the plurality of inverters 370. Additional load may change the slew rate characteristics of the ring oscillator 350.

In one embodiment, each testing sub-unit 220 includes the first ring oscillator 300 and the second ring oscillator 350. The different number of inverters in the delay lines of the two ring oscillators (i.e., 300, 350) causes the output signals to oscillate at different frequencies. Furthermore, variability in the fabrication process can cause shorter or longer delays at each of the elements (e.g., inverters) in the delay lane, causing the frequency of the signals produced by each of the ring oscillators to vary from the expected frequencies. The signals can be sampled and analyzed to determine variance in the frequency of oscillation from the expected frequency of oscillation for each of the ring oscillators.

FIG. 3C illustrates a timing diagram 380 for the output signal of the ring oscillators 310 and 350 of FIGS. 3A and 3B, in accordance with one embodiment. As shown in FIG. 3C, the output signal oscillates between a high voltage (V_{OH}) and a low voltage (V_{OL}) that represent digital logic high and digital logic low, respectively. The time t_{τ} represents the transition of the signal from digital logic high to digital logic low and is approximately equal to one delay time (i.e., the time it takes for a transition at the input of an inverter to effect the output of the inverter). Similarly, the time tₚ represents the time for half a period of the signal or the time the output signal takes to propagate through the delay line and cause the output signal to transition. In the case of the first ring oscillator 300 having 53 inverters in the delay line, the time tₚ is approximately equal to 52 times the time t_{τ}. In the case of the second ring oscillator 350 having 23 inverters in the delay line, the time tₚ is approximately equal to 22 times the time t_{τ}. The relationship between the times tₚ₁ and tₚ₂ with respect to times t_{τ1} and t_{τ2}, respectively, are shown below in Equations 1 and 2.

tₚ₁=52×t_{τ1} (Eq. 1)

tₚ₂=22×t_{τ2} (Eq. 2)

Returning now to FIGS. 2A and 2B, some testing sub-units 220, when sampled, may return values that indicate that the die 210 is faulty. For example, a ring oscillator may have a short between two of the components that causes the signal to not oscillate properly. These types of errors may be caused by fabrication processes or tools that are not functioning properly and can indicate an error to the fabrication plant. Other testing sub-units 220 may return values that are far outside of the normally expected range, again indicating that the die 210 may be faulty. When the testing sub-unit 220 returns these types of values, the die may be flagged as faulty. Conventionally, when the testing sub-units 220 return values within the expected ranges, the die 210 is considered reliable, and if each of the sampled die 210 of the wafer 200 are considered reliable (or at least a threshold number of the sampled die), then the wafer 200 is classified as reliable and the wafer 200 may be sliced and each of the die 210 of the wafer 200 packaged. However, even many of the die 210 that are included on reliable wafers may be faulty. Even though each of the different testing sub-units 220 returns a value within the expected range, the die 210 may still fail full functional testing at a later stage in the production process. Thus, the technique described herein attempts to use a machine-learning process using an SVM (support vector machine) to analyze parametric data collected from a set of wafers with known properties to estimate a classification of new wafers that is more accurate than conventional methodology.

### Support Vector Machine

Support vector machines are computer-learning models that receive input data and predict a classification of the input data based on a model generated using a set of training data. Given a set of training data (i.e., feature vectors for a large number of sample die) having corresponding classifications (i.e., pass/fail/unknown), the support vector machine training algorithm generates a model that assigns new input data to one category or the other. In other words, parametric data from a set of wafers may be analyzed by the support vector machine training algorithm to generate a model. In one embodiment, parametric data from approximately 10,000 die or more may be analyzed to find optimal parameters for the model. The SVM training algorithm generates a set of parameters for a prediction function that defines a higher-dimension hyperplane that separates the set of feature vectors associated with die that passed a system test and the set of feature vectors associated with die that failed the system test. A subset of feature vectors that lie on a margin on each side of the hyperplane comprise the set of support vectors for the support vector machine.

In one embodiment, the set of training data may exclude any die that include feature vectors having parametric data that clearly indicates that a die should fail the system test such as parametric data that indicates a complete failure (e.g., null values) or an outlying result (e.g., a value greater than a particular number of standard deviations outside the expected range). For example only die associated with feature vectors having all values within four standard deviations of the expected range based on the design may be analyzed by the support vector machine training algorithm. In other words, die 210 having testing sub-units 220 that return null values or values far outside the expected range are excluded from the set of training data.

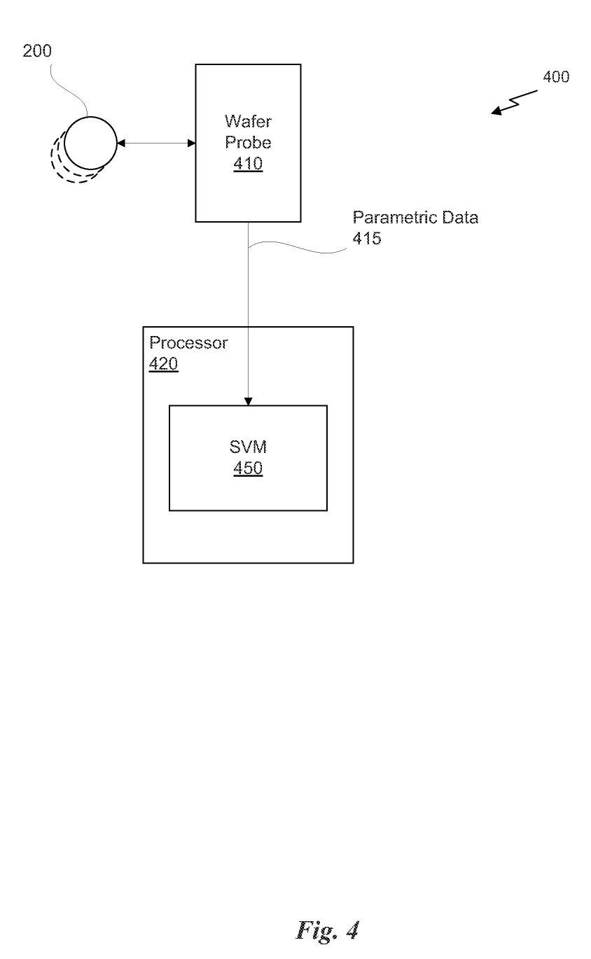

FIG. 4 illustrates a system 400 for analyzing parametric data collected from a wafer 200, in accordance with one embodiment. As shown in FIG. 4, the system 400 includes a wafer probe 410 and a processor 420 that is configured to implement a support vector machine 450. The wafer probe 410 is a specialized piece of fabrication equipment that is configured to contact a probe to the surface of the wafer 200, thereby coupling one or more die 210 on the wafer 200 with one or more electrical signals. The wafer probe 410 is configured to apply power to the one or more die 210 and sample the testing sub-units 220 to collect parametric data 415 associated with the one or more sample die 210 on the wafer 200. The wafer probe 410 may be configured to move the probe to different portions of the wafer to sample any additional die in the subset of sample die 210.

The parametric data may be generated by sampling counter values stored in special registers within the testing sub-units 220. The counter values may be accessed through an interface implemented via the connection established by the wafer probe 410. The parametric data collected may include different measurements related to one or more ring oscillators implemented in each of the testing sub-units 220. Examples of parametric data include measuring the times t_{τ} and tₚ for each of the ring oscillators. In one embodiment, the counter values in the testing sub-units indicate a slew rate (i.e., the time it takes the output to change from V_{OL} to V_{OH} or from V_{OH} to V_{OL}). In another embodiment, a ring oscillator is designed with long metal traces between delay elements, which adds additional capacitive and resistive loads between inverter stages. In such embodiments, high counter values may indicate large resistance of the traces and low counter values may indicate low resistance of the traces.

The processor 420 implements a support vector machine (SVM) 450, which is a computer-learning model that recognizes patterns in the parametric data 415 collected from the sample of die associated with the wafers 200. In one embodiment, the processor 420 is included in a typical desktop computer as, e.g., a central processing unit or a parallel processing unit such as a graphics processing unit. In another embodiment, the processor 420 may be implemented as a plurality of processors operating in parallel and connected via a system bus or in communication over a wired or wireless network. The support vector machine 450 implements a training algorithm that generates parameters for the prediction function based on the set of training data. For large data sets such as 10,000 or 50,000 feature vectors, where each feature vector may have hundreds of dimensions (i.e., measured values), parallel algorithms for determining the parameters for the prediction function may speed up the processing associated with the training algorithm.

Once the SVM 450 has determined the parameters of the prediction function, additional die 210 produced by the fabrication plant may be tested by the wafer probe 410. The SVM 450 receives the parametric data for the one or more die 210 and predicts a classification for the die 210 based on the output of the prediction function using the parameters established by the training algorithm. The SVM 450 predicts whether a die 210 is classified as system pass (1), system fail (−1), or unknown (0). In other words, the SVM 450 is a non-probabilistic trinary non-linear classifier.

In one embodiment, the wafer probe 410 samples each of the testing sub-units 220 on a die 210 to generate a set of parameters associated with the die 210. The set of parameters defines a feature vector x⁽ⁱ⁾ of K parameters (x⁽ⁱ⁾ε [symbol] ^{K}). Each die 210 therefore is associated with a feature vector x⁽ⁱ⁾ and a corresponding value y⁽ⁱ⁾ (y⁽ⁱ⁾ε{−1, 0, 1}) that represents one of three classifications: system pass (1), system fail (−1), and unknown (0). A predicted classification of the die 210 is defined as y′⁽ⁱ⁾ (y′⁽ⁱ⁾ε{−1, 0, 1}). Additionally, a per die wafer assignment vector is defined as w⁽ⁱ⁾ (w⁽ⁱ⁾ε{1, . . . , N}) for N wafers. In other words, for each die i, w⁽ⁱ⁾ is equal to an identification number, 1 through N, associated with a particular wafer 200.

In one embodiment, the parameters included in the feature vector may be scaled or normalized. Each of the dimensions of the feature vector read from the testing sub-units 220 may be scaled individually. In other words, the range of the raw measurements across all die 210 may be different for one parameter than another parameter. By scaling each dimension of the feature vector individually, the parameters can all be scaled to the same range (e.g., [0,2]).

As discussed earlier, a die 210 may include a number of testing sub-units 220, each testing sub-unit 220 including one or more ring oscillators. In one embodiment, each testing sub-unit 220 may include the first ring oscillator 300 and the second ring oscillator 350 described in FIGS. 3A and 3B. The testing sub-unit 220 may be configured to calculate a ring oscillator ratio. The ring oscillator ratio is a comparison of a value associated with the first ring oscillator 300 to a value associated with the second ring oscillator 350 and is a reflection of the leakage current versus drive strength of the transistors in the ring oscillators at a particular location on the die 210. Propagation delay in the ring oscillator is a factor of the number of stages in the delay line (i.e., the number of inverters) and the transition time per stage. A value (RO) for each ring oscillator is given by dividing the macro sample time for the ring oscillator by the sum of the time t, and the time tₚ, described by Equations 1 and 2 shown above. The macro sample time for both the first ring oscillator 300 and the second ring oscillator 350 is the same and, therefore, the ring oscillator ratio may be calculated as shown below in Equations 3 through 7.

$$\begin{matrix}\frac{{t}_{sample}}{( {t}_{τ } + {t}_{p} )} = RO & ( Eq . 3 ) \\ {RO}_{1} * ( {t}_{τ2} + {t}_{p 2} ) = {RO}_{2} * ( {t}_{τ 1} + {t}_{p 1} ) & ( Eq . 4 ) \\ ( {t}_{τ 1} * {t}_{p 1} ) = 53 * {t}_{τ1} & ( Eq . 5 ) \\ ( {t}_{τ 2} + {t}_{p 2} ) = 23 * {t}_{τ2} & ( Eq . 6 ) \\ \frac{{RO}_{1}}{{RO}_{2}} = \frac{23 {t}_{τ 2}}{53 {t}_{τ 1}} & ( Eq . 7 ) \\ {t}_{τ} = \frac{{C}_{L} * {V}_{DD}}{{I}_{MAX}} & ( Eq . 8 )\end{matrix}$$

The transition time t_{τ} for each ring oscillator is calculated using the simplification given in Equation 8. As described above, the second ring oscillator 350 has a fan-out of 4 (FO4), which means the capacitance C_{L} of the second ring oscillator for calculating the transition time t_{τ2} is four times the capacitance C_{L} of the first ring oscillator for calculating the transition time t_{τ1}. When the process is aligned and assuming some simplifications, the ring oscillator ratio for the first ring oscillator 300 and the second ring oscillator 350 is illustrated by Equation 9.

$$\frac{{RO}_{1}}{{RO}_{2}} = \frac{23 * \frac{4 * {C}_{L} * {V}_{DD}}{{I}_{MAX}}}{53 * \frac{{C}_{L} * {V}_{DD}}{{I}_{MAX}}} = 1.73 \qquad ( Eq . 9 )$$

Taking into account that the simplifications made above remove some necessary information and differences between the two ring oscillators, the ring oscillator ratio for the two ring oscillators described in FIGS. 3A and 3B is actually closer to 1.09 than the simplified 1.73 shown by solving Equation 9. The feature vectors x⁽ⁱ⁾ can be generated for a number of sample die 210 on a wafer 200 by measuring the ring oscillator ratios for a plurality of testing sub-units 220 of a die 210, and a prediction of a classification for each of the sample die 210 may be determined based on the prediction function.

For example, in one embodiment, counters within the testing sub-unit 220 may be configured to measure a value for time t_{τ} plus time tₚ for both the first ring oscillator 300 and the second ring oscillator 350. The counter values are divided to calculate the ring oscillator ratio for the testing sub-unit 220. The wafer probe 410 samples a register that stores the value for the ring oscillator ratio for a plurality of different testing sub-units 220 of the die 210. The resulting feature vector is then operated on by the prediction function to generate a predicted classification of the die 210 (i.e., either 1, 0, or −1). It will be appreciated that the ring oscillator ratio is expected to be close to the value of 1.09, shown above, and that deviation from this expected value may indicate that the die 210 is not reliable. While each of the measured values may be close to the expected 1.09, the combination of different levels of deviation at different locations in each of the die 210 may indicate that the die is faulty, as the SVM 450 is applied to the feature vector.

In one embodiment, the SVM 450 implements a non-linear classification using a Gaussian kernel function. The Gaussian kernel function K is illustrated below in Equation 10.

K(x⁽ⁱ⁾,x^{(j)})=e^{-γ*∥x}^{⁽ⁱ⁾}^{-x}^{^{(j)}}^{∥}^{²} (Eq. 10)

The Gaussian kernel function K maps the input space to a higher-dimensional feature space. While the feature vectors may not be linearly separable in the original input space, the feature vectors may be linearly separable after being mapped to the higher-dimension feature space. A hyperplane in the higher-dimension feature space may be defined that separates the die 210 for a particular wafer 200 based on the feature vectors. The tightness of the fit of the hyperplane is controlled by the parameter γ as well as the standard SVM mechanism C (i.e., a soft margin parameter). The parameter γ is a constant that defines the radius of the Gaussian function (i.e., how fast the value of K decreases as a feature vector x⁽ⁱ⁾ moves farther away from the center of the Gaussian kernel). The standard SVM mechanism C is a parameter that enables a soft margin for the hyperplane. In other words, the soft margin enables deliberate misclassification of a small amount of the feature vectors in the training set in order to maximize the number of feature vectors that are correctly classified by the prediction function. Based on the Gaussian kernel implementation of the SVM algorithm, the prediction function implemented by SVM 450 is given in Equation 11. The parameters α⁽ⁱ⁾ and b in the prediction function are selected by the SVM training algorithm based on the set of training data. The variables x⁽ⁱ⁾ represents a support vector, the variable y⁽ⁱ⁾ represents a classification of the support vector, and the variable x is a new feature vector of a die 210 that has a classification predicted by the classification function.

f(x)=sgn(Σᵢ₌₁^{N}y⁽ⁱ⁾α⁽ⁱ⁾exp(−γ∥x⁽ⁱ⁾−x|²)+b) (Eq. 11)

Selection of the parameters γ and C is important to the effectiveness of the SVM algorithm. In order to deal with non-linearly separable data, the cost factor C (Cε [symbol] ³) enables the SVM training algorithm to deliberately misclassify certain die 210 in the training set while paying a premium in the cost function for doing so. The cost parameter allows for maximization of the margin between the higher-dimension hyperplane and the feature vectors of the set of training data while ensuring that as many examples as possible are classified correctly. The values of C are selected to give each category of y⁽ⁱ⁾ equal weight. In one embodiment, an iterative approach is used to select the best values for parameters γ and C. In one implementation of the SVM 450, an exemplary value of parameter γ is approximately 0.3548 and an exemplary value of parameter C is 10. Exemplary values for a particular design and prediction function may be different than provided above.

In one embodiment, the location of a particular die 210 is taken into account by the prediction model. In other words, a feature vector x⁽ⁱ⁾ for a die 210 includes a plurality of ring oscillator ratios for that particular die 210 as well as data relating to the location of the die on the wafer 200 (i.e., an x-coordinate and a y-coordinate) of the die 210. Differences in the location of a die 210 may change how the feature vectors are classified. For example, process differences may cause different types of defects at the edges of a wafer than at the center of a wafer.

In another embodiment, nearest neighbor elimination (NNE) is implemented within the prediction model. In other words, the feature vector x⁽ⁱ⁾ for a die 210 includes a pass/fail/missing indication for one or more nearest neighbors to the die 210. For example, for each die 210, the feature vector x⁽ⁱ⁾ may include eight dimensions for the surrounding die, each dimension taking a value of +1, 0, or −1 depending on the classification of neighboring die 210 on the same wafer 200. The classification of neighboring die 210 is provided during the initial testing of the die 210 by the wafer probe 410. If one of the values returned by the die 210 are out of specification, then the die 210 is classified as “fail” and the value associated with “fail” (e.g., −1) is added to the feature vector of all neighboring die 210.

In one embodiment, a first test stage (i.e., wafer sort) is performed after a wafer has been fabricated using the wafer probe 410. During wafer sort, clearly out of specification die 210 are labeled as “failed”, die 210 having values within specification are labeled as “passed”, and die 210 near the edge of the wafer 200 (i.e., die 210 not having neighbors on every side) may be marked “unknown”. Only a sample of die 210 on each wafer 200 may be tested. During a later test stage (i.e., catalog merge), after all die 210 have been tested, the SVM 450 model is used to analyze the data collected during wafer sort in order to provide a more accurate prediction of failed die 210 before the wafers are cut up and sent to be packaged and potentially assembled as a component into a final product. It will be appreciated that the prediction function generated by the SVM 450 will not be perfect. In other words, the predicted classification of each die 210 may be incorrect. However, based on empirical evidence, the classification of wafers 200 based on the classification of a plurality of sampled die 210 is extremely effective at separating poorly performing wafers early in the production process, increasing overall yield and decreasing the number of faulty units that are built into larger systems.

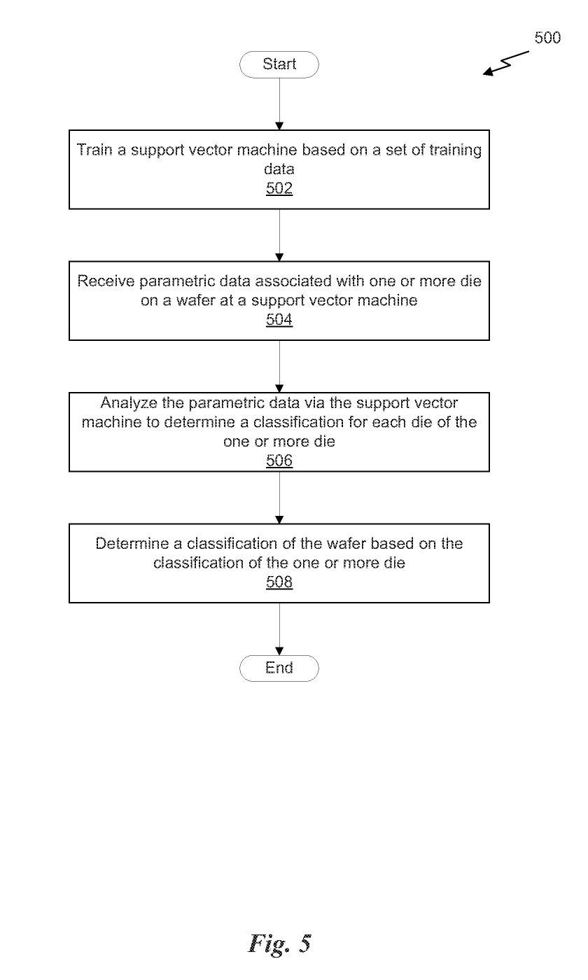

FIG. 5 illustrates a flowchart of a method 500 for testing and classifying silicon wafers 200, in accordance with one embodiment. At step 502, the SVM 450 is trained using a set of training data to generate an optimal set of parameters for the prediction model. In one embodiment, an iterative process is implemented to select an optimal combination of parameters γ and C for the prediction function set forth by Equation 11. During each iterative step, the prediction function is used to generate a cost associated with the selected parameters by determining whether, for each feature vector in the set of training data, the predicted classification of the die matches the actual classification of the die in the training data. In one embodiment, the prediction function implements a Gaussian kernel as well as a soft margin that allows misclassification of certain die in order to maximize the margin of the higher-dimension hyperplane.

At step 504, the SVM 450 receives parametric data associated with one or more die 210 on a wafer 200. In one embodiment, the parametric data includes a plurality of ring oscillator ratios collected by the wafer probe 410. Each of the ring oscillator ratios corresponds to a different location (e.g., testing sub-unit 220) on the die 210. At step 506, the SVM 450 analyzes the parametric data to determine a classification for each die 210 of the one or more die. The classification is generated by applying the prediction function to the feature vector for each of the one or more die. At step 508, a classification of the wafer is determined based on the classification of the one or more die. In one embodiment, a wafer is classified as “pass” when each of the one or more die on the wafer is classified as “pass”. In another embodiment, a wafer is classified as “pass” when at least a threshold number of die in the one or more die is classified as “pass”. In other words, a wafer may be classified as “pass” when a large percentage of sampled die are classified as “pass” (e.g., 90%).

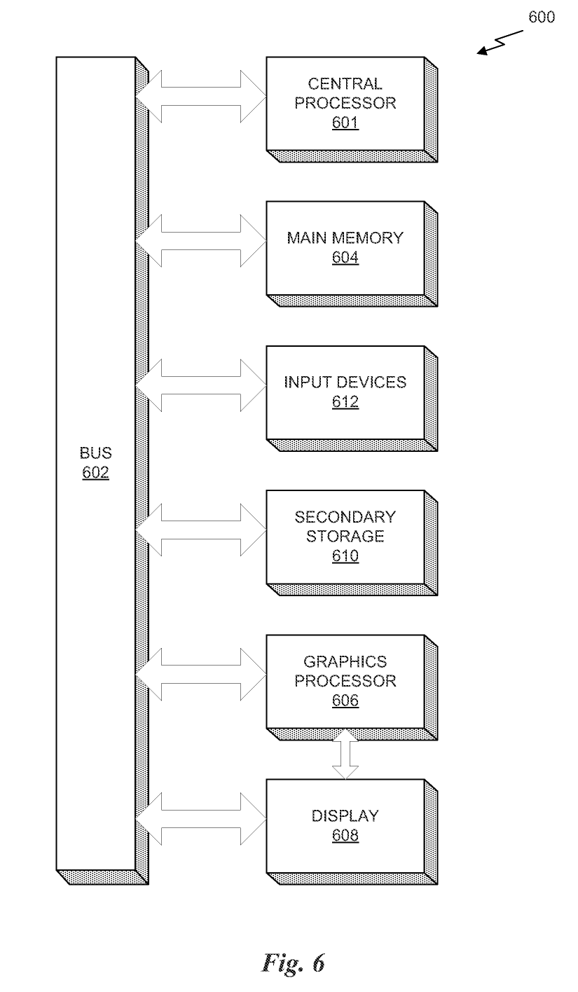

FIG. 6 illustrates an exemplary system 600 in which the various architecture and/or functionality of the various previous embodiments may be implemented. As shown, a system 600 is provided including at least one central processor 601 that is connected to a communication bus 602. The communication bus 602 may be implemented using any suitable protocol, such as PCI (Peripheral Component Interconnect), PCI-Express, AGP (Accelerated Graphics Port), HyperTransport, or any other bus or point-to-point communication protocol(s). The system 600 also includes a main memory 604. Control logic (software) and data are stored in the main memory 604 which may take the form of random access memory (RAM).

The system 600 also includes input devices 612, a graphics processor 606, and a display 608, i.e. a conventional CRT (cathode ray tube), LCD (liquid crystal display), LED (light emitting diode), plasma display or the like. User input may be received from the input devices 612, e.g., keyboard, mouse, touchpad, microphone, and the like. In one embodiment, the graphics processor 606 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 600 may also include a secondary storage 610. The secondary storage 810 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 604 and/or the secondary storage 610. Such computer programs, when executed, enable the system 600 to perform various functions. The memory 604, the storage 610, and/or any other storage are possible examples of computer-readable media. In one embodiment, the SVM 450 is stored in the main memory 604 or secondary storage 610 and is executed by the central processor 601 or the graphics processor 606.

In one embodiment, the architecture and/or functionality of the various previous figures may be implemented in the context of the central processor 601, the graphics processor 606, an integrated circuit (not shown) that is capable of at least a portion of the capabilities of both the central processor 601 and the graphics processor 606, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 600 may take the form of a desktop computer, laptop computer, server, workstation, game consoles, embedded system, and/or any other type of logic. Still yet, the system 600 may take the form of various other devices including, but not limited to a personal digital assistant (PDA) device, a mobile phone device, a television, etc.

Further, while not shown, the system 600 may be coupled to a network (e.g., a telecommunications network, local area network (LAN), wireless network, wide area network (WAN) such as the Internet, peer-to-peer network, cable network, or the like) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method comprising:
receiving parametric data associated with one or more die on a wafer,
analyzing the parametric data via a support vector machine to determine a classification for each die of the one or more die, wherein the parametric data includes at least one ring oscillator ratio; and
determining a classification of the wafer based on the classification of the one or more die.

2. The method of claim 1, wherein the support vector machine generates a prediction function that implements a Gaussian kernel.

3. The method of claim 1, wherein each die of the one or more die includes a plurality of testing sub-units that include at least a first ring oscillator and a second ring oscillator.

4. The method of claim 3, wherein the first ring oscillator includes a first number of elements in a first delay line and the second ring oscillator includes a second number of elements in a second delay line, and wherein the first number is not equal to the second number.

5. The method of claim 3, wherein each testing sub-unit is configured to generate a corresponding ring oscillator ratio based on values associated with the first ring oscillator and the second ring oscillator.

6. The method of claim 5, wherein the ring oscillator ratio is computed by counting a first number of clock cycles that represent half the period of the output signal of the first ring oscillator and counting a second number of clock cycles that represent half the period of the output signal of the second ring oscillator and dividing the first number of clock cycles by the second number of clock cycles.

7. The method of claim 1, wherein the classification of each die is set to pass, fail, or unknown.

8. The method of claim 1, wherein the classification of the wafer is determined based on whether a number of the one or more die classified as pass is above a threshold number.

9. The method of claim 1, further comprising training the support vector machine to determine parameters for a prediction function based on a set of training data.

10. The method of claim 9, wherein training the support vector machine comprises selecting parameters γ and C for the prediction function such that the maximum number of die in the set of training data are properly classified based on the prediction function.

11. The method of claim 10, wherein selecting the parameters γ and C is performed via an iterative process by selecting different combinations of the parameters γ and C and calculating a cost function based on the predicted classifications of each of the die in the set of training data.

12. The method of claim 1, wherein the parametric data for each die includes at least two ring oscillator ratios corresponding to two different testing sub-units located at different points on the die.

13. The method of claim 1, wherein the parametric data for each die includes data associated with at least one neighboring die.

14. The method of claim 13, wherein the data associated with at least one neighboring die is a value that represents whether the neighboring die is predicted to pass or fail a system test.

15. The method of claim 1, wherein the parametric data for each die includes a location of the die represented as an x-coordinate and a y-coordinate.

16. A non-transitory computer-readable storage medium storing instructions that, when executed by a processor, cause the processor to perform steps comprising:
receiving parametric data associated with one or more die on a wafer,
analyzing the parametric data via a support vector machine to determine a classification for each die of the one or more die, wherein the parametric data includes at least one ring oscillator ratio; and
determining a classification of the wafer based on the classification of the one or more die.

17. The non-transitory computer-readable storage medium of claim 16, wherein each die of the one or more die includes a plurality of testing sub-units that include at least a first ring oscillator and a second ring oscillator, and wherein the first ring oscillator includes a first number of elements in a first delay line and the second ring oscillator includes a second number of elements in a second delay line, and wherein the first number is not equal to the second number.

18. A system, comprising:
a memory storing parametric data associated with one or more die on a wafer; and
a processor configured to:
receive the parametric data associated with the one or more die,
analyze the parametric data via a support vector machine to determine a classification for each die of the one or more die, wherein the parametric data includes at least one ring oscillator ratio, and
determine a classification of the wafer based on the classification of the one or more die.

19. The system of claim 18, the processor further configured to train the support vector machine to determine parameters for a prediction function based on a set of training data.

20. The system of claim 19, wherein the prediction function implements a Gaussian kernel.
